(19) United States
(12) Patent Application Publication
(10) Pub. No.: US 2015/0371183 A1
(43) Pub. Date: Dec. 24, 2015

(54) SYSTEMS AND METHODS FOR CONFIDENTIAL SHIPPING

(71) Applicant: UNITED PARCEL SERVICE OF AMERICA, INC., ATLANTA, GA (US)

(72) Inventor: DUANE ANDERSON, Midlothian, VA (US)

(21) Appl. No.: 14/310,823

(22) Filed: Jun. 20, 2014

(51) Int. Cl. G06Q 10/08

(52) U.S. Cl. CPC G06Q 10/0833

(57) ABSTRACT

Systems, methods, apparatus, and computer program products are provided for providing confidential shipping solutions. In some embodiments, a system may offer a confidential shipment program to a customer. In this program, the link between a shipper and a consignee may be kept confidential through the use of exception processing. In various embodiments, the exception processing may include removing or obscuring references to the shipper from the physical item/shipment and providing a label for the item/shipment that includes shipping instructions without a reference to the shipper.

### BACKGROUND

Shipping customers are increasing their expectations regarding various delivery services. Thus, new concepts are needed to enhance customer experience and loyalty by improving the delivery experience.

### BRIEF SUMMARY

In general, embodiments of the present invention provide systems, methods, apparatus, and computer program products for confidential shipping options.

In accordance with one aspect, a method for confidential delivery of an item is provided. The method includes the steps of receiving, via one or more processors, shipment data corresponding to an item to be delivered to a delivery point by a carrier for a customer; generating, via one or more processors, an outbound item identifier and an inbound identifier; associating an outbound shipping label with the item, wherein the outbound shipping label identifies the outbound item identifier and does not identify a consignee; capturing, via one or more processors, the outbound item identifier from the outbound shipping label and identifying the item as a confidential shipment; removing or obscuring the outbound shipping label following identification as a confidential shipment; associating an inbound shipping label with the item, wherein the inbound shipping label identifies the delivery point and does not identify a shipper; and delivering the item to the delivery point.

In another aspect of the invention, an apparatus including at least one processor and at least one memory including computer program code is provided. The at least one memory and the computer program code are configured to, with the processor, cause the apparatus to at least: store shipment data corresponding to an item to be delivered to a delivery point by a carrier for a customer; generate an outbound item identifier and an inbound identifier; generate an outbound shipping label for association with the item, wherein the outbound shipping label identifies the outbound item identifier without identifying the consignee; capture the outbound item identifier from the outbound shipping label and identify the item as a confidential shipment; generate an inbound shipping label for association with the item, wherein the inbound shipping label identifies the inbound item identifier and does not identify the shipper and the delivery point; associating an inbound shipping label with the item following removal of the outbound shipping label; receiving a tracking request comprising the outbound item identifier or the inbound identifier; and providing tracking information in response to the tracking request.

In a further aspect of the invention, a computer program product is provided. The computer program product includes at least one non-transitory computer-readable storage medium having computer-readable program code portions stored therein. The computer-readable program code portions include: an executable portion configured to store shipment data corresponding to an item to be delivered to a delivery point by a carrier for a customer; an executable portion configured to generate an outbound item identifier and an inbound identifier; an executable portion configured to generate an outbound shipping label for association with the item, wherein the outbound shipping label identifies the outbound item identifier without identifying the consignee; an executable portion configured to capture the outbound item identifier from the outbound shipping label and identify the item as a confidential shipment; an executable portion configured to generate an inbound shipping label for association with the item, wherein the inbound shipping label identifies the inbound item identifier and does not identify the shipper and the delivery point; an executable portion configured to associating an inbound shipping label with the item following removal of the outbound shipping label; an executable portion configured to receiving a tracking request comprising the outbound item identifier or the inbound identifier; and an executable portion configured to providing tracking information in response to the tracking request.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a mobile station according to one embodiment of the present invention.

FIG. 4 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Exemplary System Architecture

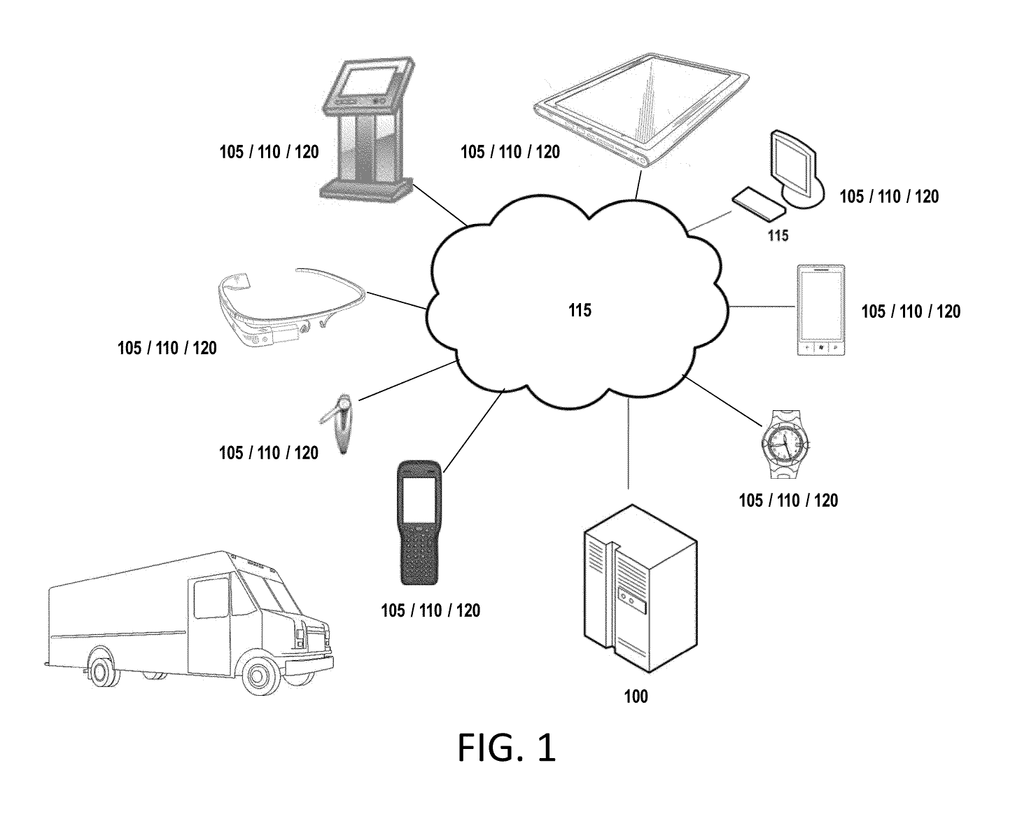

FIG. 1 provides an illustration of a system that can be used in conjunction with various embodiments of the present invention. As shown in FIG. 1, the system may include one or more carrier systems 100, one or more mobile stations 105, one or more consignee computing devices 110, and one or more networks 115, and one or more consignor computing devices 120. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain communication system entities as separate, standalone entities, the various embodiments are not limited to this particular architecture.

### 1. Exemplary Carrier System

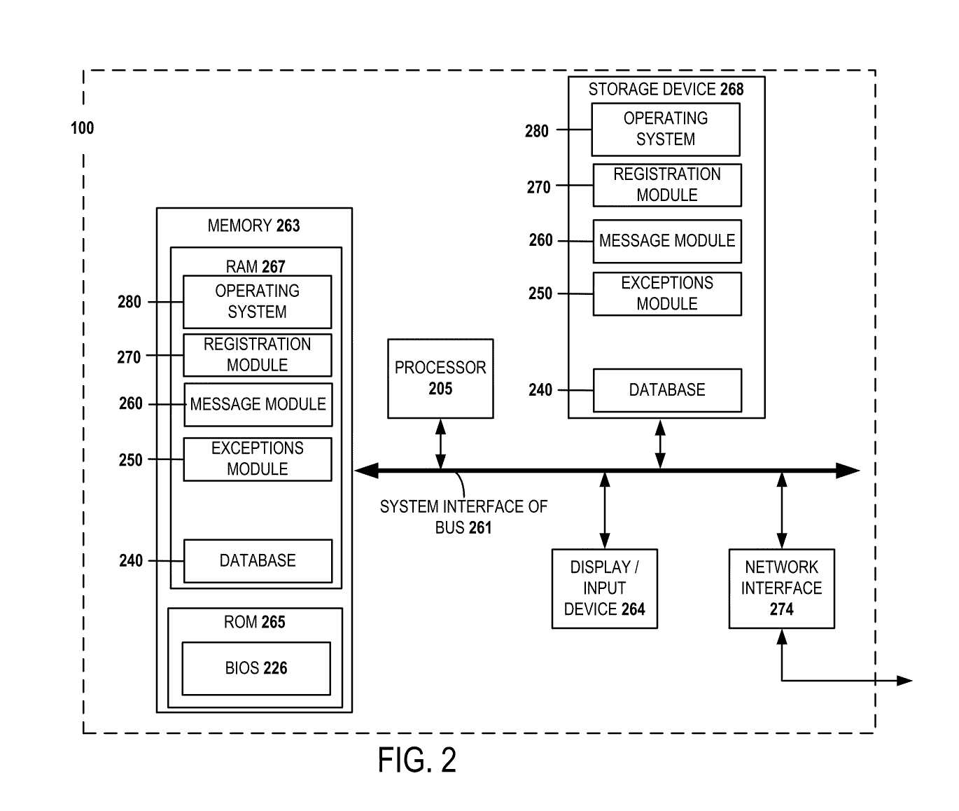

FIG. 2 provides an exemplary schematic of a carrier system 100 according to one embodiment of the present invention. In general, the term “system” may refer to, for example, one or more computers, computing entities, computing devices, mobile phones, gaming consoles (e.g., Xbox, Play Station, Wii), desktops, tablets, notebooks, laptops, distributed systems, servers or server networks, blades, gateways, switches, processing devices, processing entities, set-top boxes, relays, routers, network access points, base stations, the like, and/or any combination of devices or entities adapted to perform the functions, operations, and/or processes described herein. However, the carrier system 100 may also comprise various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components. The carrier system 100 may also be in communication with various payment networks/systems for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like.

As will be understood from FIG. 1, in one embodiment, the carrier system 100 includes one or more processors 205 that communicate with other elements within the carrier system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the carrier system 100. This display device/input device 264 may be, for example, a keyboard or pointing device that is used in combination with a monitor. The carrier system 100 may further include transitory and non-transitory memory 263, which may include both random access memory (RAM) 267 and read only memory (ROM) 265. The carrier system's ROM 265 may be used to store a basic input/output system (BIOS) 226 containing the basic routines that help to transfer information to the different elements within the carrier system 100.

In addition, in one embodiment, the carrier system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, a registration module 270, an alert module 260, an exceptions module 250, and/or the like. As discussed in more detail below, these executable instructions, applications, program modules, and/or the like may control certain aspects of the operation of the carrier system 100 with the assistance of the processor 205 and operating system 280—although their functionality need not be modularized. In addition to the program modules, the carrier system 100 may store or be in communication with one or more databases, such as database 240.

Also located within the carrier system 100, in one embodiment, is a network interface 274 for interfacing with various computing entities (e.g., with one or more mobile stations 105). For example, the carrier system 100 may be able to receive data and/or messages from and transmit data and/or messages to the mobile station 105, consignee computing devices 110, and consignor computing devices 120. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the carrier system's 100 components may be located remotely from other carrier system 100 components. Furthermore, one or more of the components may be combined and additional components performing functions described herein may be included in the carrier system 100.

### 2. Exemplary Mobile Station

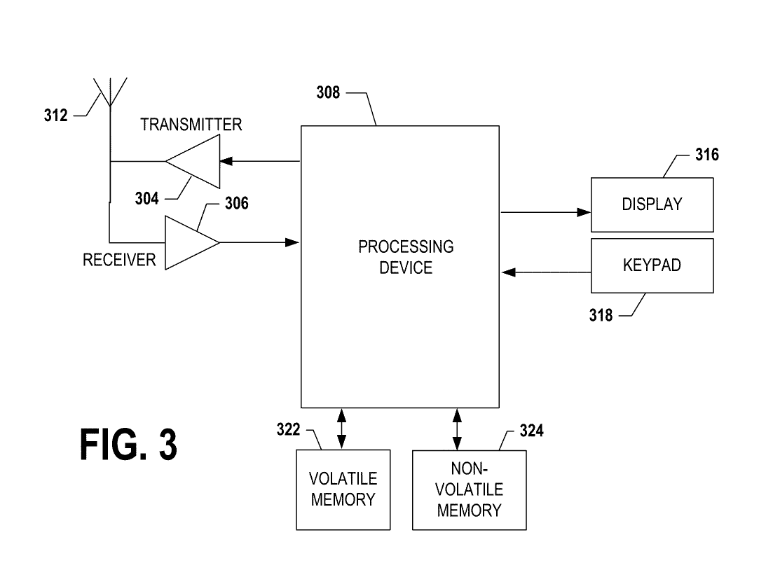

FIG. 3 provides an illustrative schematic representative of a mobile station 105 that can be used in conjunction with the embodiments of the present invention. Mobile stations 105 can be operated by various parties, including carrier personnel (e.g., delivery drivers, sorters, and/or the like). As shown in FIG. 3, the mobile station 105 can include an antenna 312, a transmitter 304 (e.g., radio), a receiver 306 (e.g., radio), and a processing device 308 (e.g., a processor, controller, and/or the like) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile station 105 may be capable of operating with one or more air interface standards, communication protocols, modulation types, and access types. More particularly, the mobile station 105 may operate in accordance with any of a number of wireless communication standards and protocols, such as those described above with regard to the carrier system 100. In a particular embodiment, the mobile station 105 may operate in accordance with multiple wireless communication standards and protocols (e.g., using a Gobi radio), such as such as 802.11, GPRS, UMTS, CDMA2000, 1xRTT, WCDMA, TD-SCDMA, LTE, E-UTRAN, EVDO, HSPA, HSDPA, Wi-Fi, WiMAX, UWB, IR, Bluetooth™, wireless USB protocols, and/or any other wireless protocol and/or multiple wireless carriers. To do so, the mobile station 105 may include integrated mobile reception diversity and integrated power management. Such a configuration can provide for global connectivity to the user.

Via these communication standards and protocols, the mobile station 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 105 can also download changes, add-ons, and updates, for instance, to its firmware, software (e.g., including executable instructions, applications, program modules), and operating system.

According to one embodiment, the mobile station 105 may include a location determining device and/or functionality. For example, the mobile station 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 105 may also comprise a user interface (that can include a display 316 coupled to a processing device 308) and/or a user input interface (coupled to the processing device 308). The user input interface can comprise any of a number of devices allowing the mobile station 105 to receive data, such as a keypad 318, a touch display, voice or motion interfaces, or other input device. In embodiments including a keypad 318, the keypad 318 can include the conventional numeric (0-9) and related keys (#, *), and other keys used for operating the mobile station 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 105 can also include volatile memory 322 and/or non-volatile memory 324, which can be embedded and/or may be removable. For example, the non-volatile memory may be embedded or removable MMCs, secure digital SD memory cards, Memory Sticks, EEPROM, flash memory, hard disk, or the like. The memory can store any of a number of pieces or amount of information and data used by the mobile station 105 to implement the functions of the mobile station 105. The memory can also store content, such as computer program code for an application and/or other computer programs.

### 3. Exemplary Consignee Computing Device

The consignee computing devices 110 may each include one or more components that are functionally similar to those of the carrier system 100 and/or mobile station 105. For example, in one embodiment, each of the consignee computing devices may include: (1) a processor that communicates with other elements via a system interface or bus; (2) a user interface; (3) transitory and non-transitory memory; and (4) a communications interface. As noted, the consignee computing device 110 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the consignee computing device 110 to interact with and/or cause display of information from the carrier system 100, as described herein. These architectures are provided for exemplary purposes only and are not limiting to the various embodiments. In general, the terms device, system, computing entity, entity, and/or similar words used herein interchangeably may refer to, for example, one or more computers, computing entities, mobile phones, desktops, tablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. A customer may refer to either a consignor (e.g., a party shipping an item via carrier) or a consignee (e.g., a party receiving an item from a carrier). In the returns context, a consignee who received an item can become a consignor when returning an item.

### 4. Exemplary Consignor Computing Device

The consignor computing devices 120 may each include one or more components that are functionally similar to those of the carrier system 100, mobile station 105, and/or consignee computing device 110. For example, in one embodiment, each of the consignor computing devices may include: (1) a processor that communicates with other elements via a system interface or bus; (2) a user interface; (3) transitory and non-transitory memory; and (4) a communications interface. As noted, the consignor computing device 120 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the consignor computing device 120 to interact with and/or cause display of information from the carrier system 100, as described herein. These architectures are provided for exemplary purposes only and are not limiting to the various embodiments. A customer may refer to a consignor (e.g., a party shipping an item via carrier), a consignee (e.g., a party receiving an item from a carrier) a third party, and/or the like. In the returns context, a consignor who shipped an item can become a consignee when an item is being returned.

### III. Exemplary System Operation

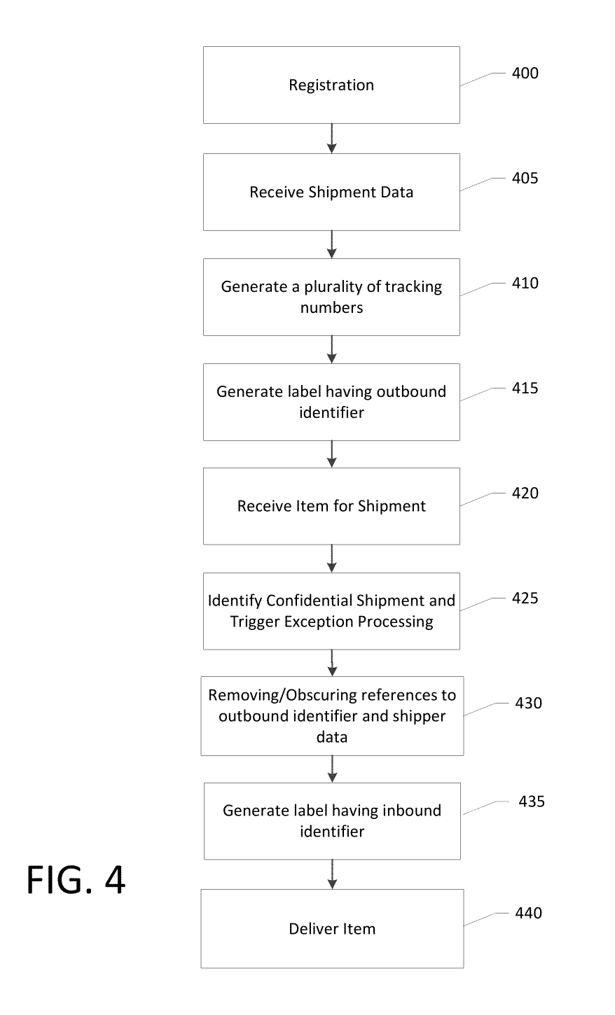

Reference will now be made to FIG. 4 which is a flowchart illustrating operations and processes that may be performed for confidential shipments.

### 1. Registration

In one embodiment, as indicated in Block 400 of FIG. 4, the process may begin with the enrollment/registration of one or more customers (e.g., consignors and/or consignees) for a customer pickup, delivery, and/or returns program. A customer (e.g., consignor or consignee) may be an individual, a family, a company, an organization, an entity, a department within an organization, a representative of an organization and/or person, and/or the like. To register, a customer (e.g., a customer or customer representative operating a consignee computing device 110 or consignor computing device 120) may access a webpage, application, dashboard, browser, or portal of a carrier, such as United Parcel Service of America, Inc. (UPS). For instance, the carrier system 100 may transmit a webpage that provides the customer with an option of logging into a customer account or enrolling/registering for a customer pickup, delivery, and/or returns program.

In one embodiment, as part of the enrollment/registration process, the customer (e.g., operating a consignee computing device 110 or consignor computing device 120) may be requested to provide biographic and/or geographic information by the carrier system 100 (e.g., via the registration module 270). Such information may be manually input or provided by allowing access to other accounts, such as Facebook, Gmail, Twitter, PayPal, and/or the like. For instance, the customer may provide the customer's name, such as a first name, a last name, a company name, an entity name, and/or an organization name. The customer (e.g., consignor or consignee) may also provide any aliases associated with the customer. For instance, if the customer (e.g., consignor or consignee) were an individual named Joseph Brown, the customer (e.g., consignor or consignee) may provide Joe Brown or Joey Brown as aliases.

The customer (e.g., consignor or consignee) may also provide one or more physical addresses associated with the customer (e.g., street address, city, state, postal code, and/or country) to the carrier system 100. For instance, Joseph Brown's primary residential address of 105 Main Street, Atlanta, Ga. 30309, USA, may be provided to the carrier system 100. Further, one or more secondary residential addresses may also be provided to the carrier system 100 for association with Mr. Brown's account and profile, such as 71 Lanier Islands, Buford, Ga. 30518, USA. As will be recognized, the residential addresses may include weekend residences, family member residences visited by the customer, and/or the like. Additionally, the customer (e.g., consignor or consignee) may also provide one or more business addresses associated with the customer (e.g., street address, city, state, postal code, and/or country) to the carrier system 100. For example, Mr. Brown may have a primary business address of 1201 W Peachtree, Atlanta, Ga. 30309, USA. One or more secondary business addresses may also be provided to the carrier system 100 for association with Mr. Brown's account and profile, such as 101 South Tryon Street, Charlotte, N.C. 28280, USA; 950 F Street, NW, Washington, D.C. 20004, USA; and 90 Park Avenue, New York, N.Y. 10016, USA. As will be recognized, the business addresses may include various office locations for a single enterprise, multiple office locations for various enterprises, and/or the like. As will be recognized, the customer (e.g., consignor or consignee) may provide other biographic and/or geographic information to adapt to various needs and circumstances.

In one embodiment, once the carrier system 100 receives the necessary biographic and/or geographic information from the customer, the carrier system 100 may perform one or more validation operations. For example, the carrier system 100 may determine whether the primary address (and/or other addresses) in the specified country or postal code is eligible for a customer pickup, delivery, and/or returns programs. The carrier system 100 may also determine whether the primary address (and/or other addresses) is valid, e.g., by passing the primary address through one or more address cleansing or standardization systems. The carrier system 100 may perform a variety of fraud prevention measures as well, such as determining whether the customer (e.g., consignor or consignee) or one of the customer's addresses has been “blacklisted” from customer pickup, delivery, and/or returns programs. As will be recognized, a variety of other approaches and techniques can be used to adapt to various needs and circumstances.

In one embodiment, the carrier system 100 may create a customer profile for the customer via the enrollment/registration process. Accordingly, the carrier system 100 may create and store various customer profiles (e.g., via database 240). In addition to at least the information described above, a customer profile may include one or more corresponding usernames and passwords. As will be recognized, each of the physical addresses may be associated with the customer's profile.

In one embodiment, in addition to the physical addresses, the customer (e.g., operating a customer computing device 110/120) may also input, request, or be automatically generated and assigned a “virtual address.” The virtual address can be stored by the carrier system 100 in association with the customer's profile. For example, Joseph Brown (e.g., operating a customer computing device 110/120) may input a request for a unique virtual address such as BigBrown8675309 or any other unique virtual address. In another embodiment, the carrier system 100 may automatically generate and assign a unique virtual address for the customer, such as assigning virtual address 1XR457 to Joseph Brown. Such virtual addresses can be used by customers who do not want to (a) provide their physical addresses to merchants or other third parties, (b) have their physical addresses printed on labels placed on the exterior of items, and/or (c) the like. For instance, this may enable a consignor to ship a package using only BigBrown8675309 or 1XR457 as the destination address (e.g., virtual address) using the appropriate carrier. Upon ingestion of the package into the carrier's transportation and logistics network, the carrier personnel can read (e.g., manually or with the aid of a device) the virtual address on the item (e.g., BigBrown8675309 or 1XR457), look up the appropriate physical delivery address for the item based on the consignee's profile (e.g., search for the customer profile associated with the virtual address), and route the item accordingly (including the use of automatic service schedules). In certain embodiments, the item may be routed only using the virtual address. That is, as an item is handled by carrier personnel, a mobile station 105 (in communication with the carrier system 100) operated by the carrier personnel can cause display of the appropriate handling or routing instructions while masking the actual physical delivery address. In other embodiments, however, once the item with the virtual address is ingested into the carrier's transportation and logistics network, carrier personnel may place a label on the item that indicates the physical delivery address (e.g., based on an address associated with the profile and/or automatic service schedule). Such virtual address concepts are disclosed in U.S. Pat. No. 8,108,321, which is hereby incorporated in its entirety by reference. Both physical addresses and virtual addresses may be referred to herein interchangeably as “addresses.”

In addition to the virtual address, the carrier system 100 may also generate and store an internal customer identifier in association with the customer profile. In one embodiment, a customer identifier may be used to uniquely identify a customer profile. In another embodiment, a customer identifier may be used to uniquely identify a given address (e.g., physical address or virtual address) associated with a customer profile. In such an embodiment, if a customer profile is associated with four addresses, the carrier system 100 may generate and store four customer identifiers in association with the customer profile (or use one customer identifier for all the addresses for the customer). The customer identifier may also be stored in association with shipment data for an item to associate the item (and its shipment data) with the (a) correct customer (e.g., customer profile) and/or (b) correct address for a customer.

In one embodiment, a customer profile may correspond to one or more customer pickup, delivery, and/or returns programs. For instance, a customer (e.g., operating a customer computing device 110/120) may subscribe to a specific customer pickup, delivery, and/or returns program. For example, the customer pickup, delivery, and/or returns program may allow customers to have access to certain features, e.g., pickup and delivery alerts, approximate pickup and delivery times, change pickup and delivery options, electronically authorize the release of an item, and/or route items to will call. Additional features may include, routing items to other retail locations, rescheduling pickups and deliveries, requesting that items be delivered to another address, and/or provide instructions for pickup or delivery. In the event some or all of these features are require payment of a fee, the payments may be in a variety of forms, such as via debit card, credit card, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. As will be recognized, these features are provided for illustrative purposes and are not limiting to embodiments of the present invention. Moreover, a variety of other approaches and techniques can be used to adapt to various needs and circumstances.

In some embodiments, the carrier system may offer the customer a confidential shipment program. In this program, the link between the shipper and the consignee may be kept confidential through the use exception processing. In various embodiments, the exception processing may include removing or obscuring references to the shipper from the physical item/shipment and providing a label for the item/shipment that includes shipping instructions without a reference to the shipper.

In one embodiment, after a customer profile has been created by the carrier system 100, the customer (e.g., operating a customer computing device 110/120) can provide various preferences associated with the customer delivery program to the carrier system 100 via a webpage, for example. For instance, the customer (e.g., operating a customer computing device 110/120) can provide a variety of preferences, such communication preferences, service schedule preferences, delivery preferences, delivery options, and/or delivery instructions. The customer (e.g., operating a customer computing device 110/120) may also update any information through the appropriate interface (e.g., browser, dashboard, webpage, application).

### 2. Scheduling a Confidential Shipment

In one embodiment, the shipper may initiate the shipping process by entering identifying information which would be received at the carrier system 100 at Block 405. A shipper may be an individual, a family, a company, an organization, an entity, a department within an organization, a representative of an organization and/or person, and/or the like. In various embodiments, the shipper (e.g., a shipper or shipper representative operating a shipper computing device 120) may access a webpage or portal of a carrier, such as United Parcel Service of America, Inc. (UPS). For instance, the carrier system 100 may transmit a webpage that provides the shipper with an option of logging into an existing account, registering for a new account or entering shipping information as a “guest” for a customer pickup and/or delivery of an item.

Assuming the shipper already has a shipper account or has established a new account as described above, the shipper (e.g., a shipper or shipper representative operating a shipper computing device 120) may login to the webpage or portal, e.g., by providing an associated username and password. Alternatively, the shipper may enter identifying information as a “guest” without establishing an account.

Once the shipper is identified (e.g., as an account holder or guest), the shipper may initiate a shipment. In various embodiments, the carrier system 100 may then provide a user interface (e.g., browser, dashboard, application) for the shipper to provide shipment data which includes certain details regarding the proposed shipment. In various embodiments, the shipment data may include a name, street address, city, state, postal code, country, telephone number and the like for both the shipper and the consignee. In various embodiments, the user interface may comprise a fillable form with fields including ship-from data and ship-to data. In various embodiments, some of the data fields may be pre-populated. For example, if the shipper logged into a registered account, the address data entered during registration may be pre-populated in the ship-from data fields. In some embodiments, the shipper may also have an associated address book comprising address data for possible consignees (e.g., ship-to addresses).

In one embodiment, once the carrier system 100 receives the ship-to and ship-from information from the shipper, the carrier system 100 may perform one or more validation operations. For example, the carrier system 100 may determine whether the ship-to and ship-from is eligible for a pickup or delivery. The carrier system 100 may also determine whether the ship-to and ship-from is valid, e.g., by passing the ship-to and ship-from through one or more address cleansing or standardization systems. The carrier system 100 may perform a variety of fraud prevention measures as well, such as determining whether the ship-to and ship-from addresses have been “blacklisted” from customer pickup and/or delivery. As will be recognized, a variety of other approaches and techniques can be used to adapt to various needs and circumstances.

In addition to ship-to and ship-from data, the shipment data may also include information regarding the shipment itself. For the example, the number of packages, the weight and sizes of the packages and the service level. The service level options may be for example Next Day Air, Next Day Air Early AM, Next Day Air Saver, 2nd Day Air, 2nd Day Air Early AM, 3 Day Select, Ground, and/or SurePost.

In various embodiments, the user may be provided a confidential shipment option. If selected, the shipper may be prompted to provide confidential shipment data. The confidential shipment data may include virtual ship-to and virtual ship-from addresses. In some embodiments, carrier system 100 may be retrieved virtual addresses from the consignee and/or shipper profiles for use as ship-to and virtual ship-from addresses. In some embodiments, the user may be allowed to alter the retrieved virtual addresses and/or provide different virtual addresses. In further embodiments, the carrier system 100 may generate virtual ship-to and/or ship-from addresses for specific shipments. The virtual addresses may mimic a standard address format (e.g., name, street address, city, state and zipcode) or have a different format. The carrier system 100 may have a list of virtual ship-to/ship-from addresses from which to choose from (by the customer or the carrier system) or may use a random number generator to create virtual ship-to/ship-from addresses.

In some embodiments, the carrier may require the consignee to consent before accepting a confidential shipment. For example, the consignee profile may include confidential shipment program authorization. In other embodiments, the carrier system 100 may send a notification to the consignee indicating a shipper desires to send a confidential shipment to the consignee. The consignee may then provide authorization in the form of a return message for the confidential shipment and may include a virtual ship-to address to be used.

In further embodiments, the shipper may be an online merchant. As part of the purchase transaction, the shipper may provide the option of a confidential shipment to the purchaser (e.g., the consignee). If selected by the purchaser, the purchaser may be prompted to enter a virtual ship-to address. In these embodiments, the shipper may communicate the purchaser's authorization for the confidential shipment and the identified virtual address.

In further embodiments, the confidential shipment may be initiated automatically by the consignee using a virtual ship-to address. This confidential shipment may be performed without notifying the shipper of the confidential nature of the delivery. For example, the consignee may provide the shipper with a virtual address for use in initiating the shipment. The shipper may then provide the actual ship-from address and the virtual ship-to address without knowing the actual ship-to address. The carrier may then initiate the confidential shipment based on the virtual address.

### 3. Shipping a Confidential Shipment

After the shipment data has been received and validated (including the confidential shipment data), the carrier system 100 may generate a master item/shipment identifier, an outbound item/shipment identifier and/or an inbound item/shipment identifier at Block 410 of FIG. 4. The master item/shipment identifier, an outbound item/shipment identifier and/or an inbound item/shipment identifier may be used by the carrier to identify and track the item as it moves through at least a portion of the carrier's transportation network.

In various embodiments, the carrier system 100 may store the master item/shipment identifier, an outbound item/shipment identifier and/or an inbound item/shipment identifier in association with shipment data for the item. The shipment data may include information about the item delivery, such as delivery service level. For example, the delivery service level may be Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like. The shipment data may include information about the party shipping the item (e.g., consignor), such as the party's name, the party's address, the party's phone number, a ship-from address, a virtual ship-from address, and/or the like. The shipment data may also include information about the customer to whom the item is to be delivered (e.g., consignee), such as the customer's name, customer's physical address or location, the customer's phone number, a ship-to address (e.g., delivery point/location), a ship-to virtual address and/or the like. The shipment data may also include an outbound item/shipment identifier and/or an inbound item/shipment identifier. As will be recognized, the terms delivery point/location are intended encompass any identifiable location, including residences, commercial locations, stores, vehicles, boats, landmarks, and/or the like.

The carrier system 100 may generate a digital representation of an outbound label for use by the shipper for the shipment at Block 415 of FIG. 4. The outbound label may include the outbound item/shipment identifier and may include the actual ship-from address and/or the virtual ship-to address. In various embodiments, the carrier system 100 may send the digital representation of the label to the shipper computer device such that the label may be printed.

In various embodiments, the outbound label may include both human-readable indicia and machine readable indicia such as such as a barcode, a MaxiCode, electronic representation, and/or text (e.g., alphanumeric text). The outbound item/shipment identifier (as well as physical and virtual addresses) may be represented as text, barcodes, Aztec Codes, MaxiCodes, Data Matrices, Quick Response (QR) Codes, electronic representations, and/or the like. The outbound item/shipment identifier (e.g., 123456789) may be used by the carrier to identify and track the item as it moves through at least a portion of the carrier's transportation network. Further, such outbound item/shipment identifier (as well as physical and virtual addresses) can be affixed to items by, for example, using a sticker (e.g., label) with the outbound item/shipment identifier printed thereon (in human and/or machine readable form) or an RFID tag with the outbound item/shipment identifier stored therein. In various embodiments, outbound label/tag does not include information identifying the consignee such as the consignee name, address and the like. In addition, the outbound label/tag may not include the master item/shipment identifier.

### 4. Carrier Receives Item for Shipment

In various embodiments, the shipper will transfer the item to a carrier for delivery to a delivery point at Block 420. As noted above, the item may be associated with a label or RFID tag identifying an outbound item/shipment identifier. The label or RFID tag may also identify other shipment data such as for example an actual ship-from address and/or a virtual ship-to address.

In one embodiment, the carrier system 100 may collect tracking information and store the tracking information in association with the shipment data. The tracking information may reflect the item's movement in the carrier's transportation network, and may include an expected pickup or delivery date and time. To reflect the item's movement, the outbound item/shipment identifier associated with the item may be scanned or otherwise electronically read at various points as the item is transported through the carrier's transportation network. For example, the outbound item/shipment identifier may be automatically scanned by a barcode or MaxiCode device, an RFID interrogator, by a camera controller, or by a carrier employee using a handheld device (e.g., mobile station 105). In one embodiment, each time the outbound item/shipment identifier is scanned or read, an appropriate device can transmit the outbound item/shipment identifier and other appropriate information (e.g., location and time of the scan or reading) to the carrier system 100. The carrier system 100 can then receive and use the information to track the item as it is transported though the carrier's transportation network and update the shipment data accordingly.

In various embodiments, the carrier system 100 may identify the shipment as a confidential shipment based on the shipment data. For example, a flag may be set indicating the shipment is confidential. In other embodiments, the carrier system 100 may recognize that the shipment data has more than one item/shipment identifier (e.g., a master item/shipment identifier, an outbound item/shipment identifier and/or an inbound item/shipment identifier) or the virtual address may provide an indication that the shipment should be classified as confidential.

After identifying the shipment as confidential, the carrier system 100 may trigger exception processing at Block 425. For example, a notification may be sent to an automatic or manual sorting operation to offload the item/shipment for exception processing. In various embodiments the exception processing may involve removing or obscuring references to the ship-from address and the outbound tracking item/shipping identifier. In one embodiment, the exception processing includes removing the item from its packaging and repacking the item into new packaging. In other embodiments, the exception processing may include wrapping the current packaging with an opaque material to obscure previous labels and/or other indications of the source or ship-from address associated with the item. In still further embodiments, the item may be packaged in multiple layers from the shipper and the exception processing involves removing the outer layer of packing. In still other embodiments, the item/shipment may be placed into a pouch and sealed to obscure previous labels and/or other indications of the source or ship-from address associated with the item. In additional embodiments, RFID tags and/or other electronic identifying devices may be reprogrammed to remove the source information and outbound tracking information.

In addition to removing or obscuring references to the ship-from address and the outbound tracking item/shipping identifier and/or repackaging of the item/shipment, the item/shipment may be associated with a new label or RFID tag (or reprogramed RFID tag). For example, the carrier system 100 may generate a digital representation of an inbound label for use by the carrier for the shipment. The inbound label may include the inbound item/shipment identifier and may include the actual ship-to address and/or the virtual ship-from address. In various embodiments, the carrier system 100 may send the digital representation of the label to a mobile station 105 or to an attached or networked printer to be printed. After the item/shipment has been associated with the inbound label/RFID tag, the item may be place back into the delivery stream to be delivered to the actual ship-to address according to the inbound label/RFID tag.

Similar to the outbound item/shipment identifier, the inbound label may include both human-readable indicia and machine readable indicia such as such as a barcode, a MaxiCode, electronic representation, and/or text (e.g., alphanumeric text). The inbound item/shipment identifier (as well as physical and virtual addresses) may be represented as text, barcodes, Aztec Codes, MaxiCodes, Data Matrices, Quick Response (QR) Codes, electronic representations, and/or the like. The inbound item/shipment identifier (e.g., 123456789) may be used by the carrier to identify and track the item as it moves through at least a portion of the carrier's transportation network. Further, such inbound item/shipment identifier (as well as physical and virtual addresses) can be affixed to items by, for example, using a sticker (e.g., label) with the inbound item/shipment identifier printed thereon (in human and/or machine readable form) or an RFID tag with the inbound item/shipment identifier stored therein. In various embodiments, inbound label/tag does not include information identifying the shipper such as the shipper name, address and the like.

Additionally, the inbound item/shipment identifier associated with the item may be scanned or otherwise electronically read at various points as the item is transported through the carrier's transportation network. For example, the inbound item/shipment identifier may be automatically scanned by a barcode or MaxiCode device, an RFID interrogator, by a camera controller, or by a carrier employee using a handheld device (e.g., mobile station 105). In one embodiment, each time the outbound item/shipment identifier is scanned or read, an appropriate device can transmit the outbound item/shipment identifier and other appropriate information (e.g., location and time of the scan or reading) to the carrier system 100. The carrier system 100 can then receive and use the information to track the item as it is transported though the carrier's transportation network and update the shipment data accordingly.

### 5. Item Tracking

In one embodiment, by appending the shipment data with multiple item/shipment identifiers (e.g., a master item/shipment identifier, an outbound item/shipment identifier and an inbound item/shipment identifier), the carrier can establish business rules to determine the type of tracking data provided based on the item/shipment identifier received with a tracking request and/or other criteria. For instance, the carrier may provide all tracking data in response to receipt of the associated master item/shipment identifier. As noted above, a master item/shipment identifier may be associated with the shipment data which could include tracking data for the various transfer points collected in association with the outbound item/shipment identifier and/or inbound item/shipment identifier. In some embodiments, the shipper is provided with the outbound item/shipment identifier and/or the master item/shipment identifier for use with tracking requests. Similarly, the consignee may be provided with the inbound item/shipment identifier and/or the master item/shipment identifier for use with tracking requests.

In some embodiments, the carrier system 100 may provide limited tracking information with the receipt of an outbound item/shipment identifier. For example, the carrier system 100 may only provide information collected in direct association with the outbound item/shipment identifier, such as when and where the outbound item/shipment identifier is scanned or otherwise captured (e.g., upon receipt of the package, when the package is identified for exception process). In some embodiments, the carrier system may provide selected event tracking for the outbound item/shipment identifier such as for example, when the package is place on a vehicle for final delivery to the destination address and/or following actual delivery of the item/shipment (e.g., proof of delivery). Of course, the carrier system 100 may provide full or partial tracking data access with a tracking request that includes an outbound item/shipment identifier.

Similarly, the carrier system 100 may provide limited tracking information with the receipt of an inbound item/shipment identifier. For example, the carrier system 100 may only provide information collected in direct association with the inbound item/shipment identifier, such as when and where the inbound item/shipment identifier is scanned or otherwise captured (e.g., scans following relabeling during the exception process). In some embodiments, the carrier system may provide selected event tracking for the inbound item/shipment identifier such as for example, when the package is received by the carrier and/or when the item is identified for exception processing. Of course, the carrier system 100 may provide full or partial tracking data access with a tracking request that includes an inbound item/shipment identifier.

The carrier system 100 may also establish rules regarding which entities receive which item/shipment identifiers. For example, the carrier system 100 may provide the shipper with the master item/shipment identifier in connection with a shipment transaction for use with tracking requests. Additionally, the carrier system 100 may provide the consignee with the associated inbound item/shipment identifier. In other embodiments, both (or neither) the shipper and the consignee may receive the master item/shipment identifier.

### 6. Messages/Alerts

In one embodiment, customers (e.g., operating customer computing devices) can customize and/or provide communication preferences regarding items to be picked up from or delivered to the customers. For example, the communication preferences may provide customers with the ability to request messages for items before the carrier attempts to pick up or deliver items (e.g., prior to the first delivery attempt by the carrier) and/or after items have been picked up or delivered.

In one embodiment, a customer (e.g., operating a consignee computing device 110 or consignor computing device 120) can identify one or more communication formats for communicating with the customer. The communication formats may include text messages (e.g., Short Message Service (SMS) and/or Multimedia Messaging Service (MMS), email messages, voice messages, video message (e.g., YouTube, the Vine), picture message (e.g., Instagram), social media message (e.g., private social media created internally for entities, business social media (e.g., Yammer, SocialCast), or public social media (e.g., Facebook, Instagram, Twitter)), and/or a variety of other messages in various communication formats. In addition to identifying one or more communication formats, the customer (e.g., operating a customer computing device 110/120) can identify the corresponding electronic destination addresses to be used in providing information regarding items to be picked up from or delivered to the customer. For instance, for text messages, the customer may provide one or more cellular phone numbers. For email messages, the customer may provide one or more email addresses. And for voice messages, the customer may provide one or more cellular or landline phone numbers. Additionally, in one embodiment, validation operations can be performed with respect to each input electronic destination address—to ensure their accuracy. As will be recognized, a variety of other types of electronic destination addresses can be used to adapt to various needs and circumstances.

In one embodiment, customers (e.g., operating a consignee computing device 110 or consignor computing device 120) may indicate the type of messages they want to receive (e.g., the content). For example, a customer may indicate that he only wants to receive messages when the shipment data for an item indicates that an in-person signature from the customer is requested for delivery of the item, when the pickup or delivery options for the item can be changed, when instructions for pickup or delivery of the item can be provided, or when the pickup or delivery service level of the item can be changed. In another example, a customer may indicate that he wants to receive messages for all items to be picked up from or delivered to the customer with expected dates and times. In yet another embodiment, a customer may indicate the he wants to receive messages when items are routed for exception processing, for example confidential shipments. As will be recognized, customers may indicate that they want to receive messages regarding items in a variety of other circumstances as well.

In one embodiment, the carrier system 100 can automatically generate (e.g., via the message module 260) one or more messages providing information regarding an item to be delivered to the customer (Block 425 of FIG. 4) in compliance with the customer's communication preferences and the carrier's time constraints. Similarly, the carrier system 100 can automatically transmit the one or messages to the electronic destination addresses in compliance with the customer's communication preferences and the carrier's time constraints. For example, the carrier system 100 may generate and transmit an email message to Joseph Brown's email address and a text message to Joseph's cellular phone when the item/shipment has been routed for exception processing for a confidential shipment. The messages may indicate the expected delivery date and/or delivery time and a variety of other information. As will be recognized, a variety of other operations and processes may be used with embodiments of the present invention. These operations and processes can be customized to adapt to various needs and circumstances.

### 7. Shipment Invoicing

In various embodiments, the fees for the confidential shipment service may be split-charged and recorded to accounts for the consignee, the shipper, and/or another party. It may be beneficial to maintain confidentiality throughout the shipping process including invoicing. In other words, the link between the shipper and consignee may be kept confidential in customer-facing formats that are presented to anyone other than the initiating party. For example, if the shipper requests a confidential shipment service, the invoice for the shipper may include the supplemental charges for the confidential shipment in addition to the standard shipping charges. However, if the consignee requests the confidential shipment service (e.g., provided virtual address triggering confidential shipment service), the shipper's invoice may cover the charges for a virtual and a separate invoice with a split charge for the confidential service and the actual delivery going to the consignee.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for confidential delivery of an item, the method comprising:
receiving, via one or more processors, shipment data corresponding to an item to be delivered to a delivery point by a carrier for a customer;
generating, via one or more processors, an outbound item identifier and an inbound identifier;
associating an outbound shipping label with the item, wherein the outbound shipping label identifies the outbound item identifier and does not identify a consignee;
capturing, via one or more processors, the outbound item identifier from the outbound shipping label and identifying the item as a confidential shipment;
removing or obscuring the outbound shipping label following identification as a confidential shipment;
associating an inbound shipping label with the item, wherein the inbound shipping label identifies the delivery point and does not identify a shipper; and
delivering the item to the delivery point.

2. The method of claim 1 further comprising the step of:
generating, via one or more processors, a master item identifier and associating the master item identifier with the item for providing tracking information.

3. The method of claim 1, wherein outbound shipping label comprises information identifying the shipper.

4. The method of claim 1, wherein the outbound shipping label comprises information identifying a virtual ship-to address associated with the consignee.

5. The method of claim 4 further comprising the step of retrieving the virtual ship-to address, via one or more processors, from a consignee profile.

6. The method of claim 1, wherein the outbound shipping label further comprises a virtual ship-to address and the step of identifying the item as a confidential shipment is based at least in part on the virtual ship-to address.

7. The method of claim 1, wherein inbound shipping label comprises information identifying the consignee.

8. The method of claim 1, wherein the inbound shipping label comprises information identifying a virtual ship-from address associated with the shipper.

9. The method of claim 8 further comprising the step of retrieving the virtual ship-to address, via one or more processors, from a shipper profile.

10. The method of claim 1, wherein the step of removing or obscuring the outbound shipping label comprises one of repacking the item, placing the item in a second package, or wrapping the package in an opaque material.

11. The method of claim 1, wherein the step of removing or obscuring the outbound shipping label comprises removing a first layer of packaging material.

12. The method of claim 1, wherein the outbound shipping label is an RFID tag and the step of removing or obscuring the outbound shipping label comprises reprogramming the RFID tag.

13. The method of claim 1, further comprising the step of split charging fees associated with the confidential shipment.

14. An apparatus comprising at least one processor and at least one memory including computer program code, the at least one memory and the computer program code configured to, with the processor, cause the apparatus to at least:
store shipment data corresponding to an item to be delivered to a delivery point by a carrier for a customer;
generate an outbound item identifier and an inbound identifier;
generate an outbound shipping label for association with the item, wherein the outbound shipping label identifies the outbound item identifier without identifying the consignee;
capture the outbound item identifier from the outbound shipping label and identify the item as a confidential shipment;
generate an inbound shipping label for association with the item, wherein the inbound shipping label identifies the inbound item identifier and does not identify the shipper and the delivery point;
associating an inbound shipping label with the item following removal of the outbound shipping label;
receiving a tracking request comprising the outbound item identifier or the inbound identifier; and
providing tracking information in response to the tracking request.

15. The apparatus of claim 14, wherein outbound shipping label comprises information identifying the shipper.

16. The apparatus of claim 14, wherein the outbound shipping label comprises information identifying a virtual ship-to address associated with the consignee.

17. The apparatus of claim 16, wherein the memory and computer program code are further configured to, with the processor, cause the apparatus to retrieve the virtual ship-to address from a consignee profile.

18. The apparatus of claim 14, wherein inbound shipping label comprises information identifying the consignee.

19. The apparatus of claim 14, wherein the inbound shipping label comprises information identifying a virtual ship-from address associated with the shipper.

20. The apparatus of claim 19, wherein the memory and computer program code are further configured to, with the processor, cause the apparatus to retrieve the virtual ship-to address from a shipper profile.

21. The apparatus of claim 14, wherein the outbound shipping label is an RFID tag.

22. The apparatus of claim 14, wherein the memory and computer program code are further configured to, with the processor, cause the apparatus to generate a master item identifier and associating the master item identifier with the item for providing tracking information.

23. A computer program product comprising at least one non-transitory computer-readable storage medium having computer-readable program code portions stored therein, the computer-readable program code portions comprising:
an executable portion configured to store shipment data corresponding to an item to be delivered to a delivery point by a carrier for a customer;
an executable portion configured to generate an outbound item identifier and an inbound identifier;
an executable portion configured to generate an outbound shipping label for association with the item, wherein the outbound shipping label identifies the outbound item identifier without identifying the consignee;
an executable portion configured to capture the outbound item identifier from the outbound shipping label and identify the item as a confidential shipment;
an executable portion configured to generate an inbound shipping label for association with the item, wherein the inbound shipping label identifies the inbound item identifier and does not identify the shipper and the delivery point;
an executable portion configured to associating an inbound shipping label with the item following removal of the outbound shipping label;
an executable portion configured to receiving a tracking request comprising the outbound item identifier or the inbound identifier; and
an executable portion configured to providing tracking information in response to the tracking request.

24. The computer program product of claim 23, wherein outbound shipping label comprises information identifying the shipper.

25. The computer program product of claim 23, wherein the outbound shipping label comprises information identifying a virtual ship-to address associated with the consignee.

26. The apparatus of claim 25, further comprising:
an executable portion configured to retrieve the virtual ship-to address from a consignee profile.

27. The computer program product of claim 23, wherein inbound shipping label comprises information identifying the consignee.

28. The computer program product of claim 23, wherein the inbound shipping label comprises information identifying a virtual ship-from address associated with the shipper.

29. The apparatus of claim 28, further comprising:
an executable portion configured to retrieve the virtual ship-to address from a shipper profile.
